(19) United States
(12) Patent Application Publication
(10) Pub. No.: US 2015/0358303 A1
(43) Pub. Date: Dec. 10, 2015

(54) COMBINING FEED ITEMS ASSOCIATED WITH A DATABASE RECORD FOR PRESENTATION IN A FEED

(71) Applicant: salesforce.com, inc., San Francisco, CA (US)

(72) Inventors: Man Lung Hui, Seattle, WA (US); Lorne Keith Trudeau, Bainbridge Island, WA (US); Megan Danielle Hoagland, Seattle, WA (US)

(21) Appl. No.: 14/297,207

(22) Filed: Jun. 5, 2014

(51) Int. Cl. H04L 29/06; G06F 17/30

(52) U.S. Cl. CPC H04L 63/08; G06F 17/30386; G06F 17/30353

(57) ABSTRACT

Disclosed are techniques for combining feed items for presentation in a feed. For example, two feed items having different timestamps are processed. When the feed items are associated with the same database record and when a difference between the timestamps is less than or equal to a threshold, the feed items can be combined to produce a representative feed item. The representative feed item is configured to present information characterizing updates of the feed items outside of a chronological sequence of feed items in a feed when displayed on a display device.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to combining associated feed items in a feed. More specifically, this patent document discloses techniques for combining feed items associated with the same business record stored in a database system for display in the feed.

### BACKGROUND

“Cloud computing” services provide shared resources, applications, and information to computers and other devices upon request. In cloud computing environments, services can be provided by one or more servers accessible over the Internet rather than installing software locally on in-house computer systems. Technological details can be abstracted from the users who no longer have need for expertise in, or control over, the technology infrastructure “in the cloud” that supports them. By way of example, social networking services can be provided in a cloud computing context.

### BRIEF DESCRIPTION OF THE DRAWINGS

The included drawings are for illustrative purposes and serve only to provide examples of possible structures and operations for the disclosed inventive systems, apparatus, methods and computer-readable storage media for combining feed items associated with a database record for presentation in a feed. These drawings in no way limit any changes in form and detail that may be made by one skilled in the art without departing from the spirit and scope of the disclosed implementations.

FIG. 1A shows a flowchart of an example of a computer implemented method 100A for combining feed items associated with a database record for presentation in a feed, performed in accordance with some implementations.

FIG. 1B shows a flowchart of an example of a computer implemented method 100B capable of being practiced in combination with method 100A for combining feed items associated with a database record for presentation in a feed, performed in accordance with some implementations.

FIG. 1C shows a flowchart of an example of a computer implemented method 100C capable of being practiced in combination with method 100A for combining feed items associated with a database record for presentation in a feed, performed in accordance with some implementations.

FIG. 2 shows a flowchart of an example of a computer implemented method 200 for granting or prohibiting access to information in feed items based on a user permission, performed in accordance with some implementations.

FIG. 3 shows an example of a presentation of feed items in the form of a graphical user interface (GUI) as displayed on a computing device, in accordance with some implementations.

FIG. 4 shows another example of a presentation of feed items in the form of a GUI as displayed on a computing device, in accordance with some implementations.

FIG. 5 shows another example of a presentation of feed items in the form of a GUI as displayed on a computing device, in accordance with some implementations.

FIG. 6 shows another example of a presentation of feed items in the form of a GUI as displayed on a computing device, in accordance with some implementations.

FIG. 7 shows another example of a presentation of feed items in the form of a GUI as displayed on a computing device, in accordance with some implementations.

FIG. 8A shows a block diagram of an example of an environment 10 in which an on-demand database service can be used in accordance with some implementations.

FIG. 8B shows a block diagram of an example of some implementations of elements of FIG. 8A and various possible interconnections between these elements.

FIG. 9A shows a system diagram of an example of architectural components of an on-demand database service environment 900, in accordance with some implementations.

FIG. 9B shows a system diagram further illustrating an example of architectural components of an on-demand database service environment, in accordance with some implementations.

### DETAILED DESCRIPTION

Examples of systems, apparatus, methods and computer-readable storage media according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations also referred to herein as “blocks” have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the blocks of methods shown and described herein are not necessarily performed in the order indicated. It should also be understood that the methods may include more or fewer blocks than are indicated. In some implementations, blocks described herein as separate blocks may be combined. Conversely, what may be described herein as a single block may be implemented in multiple blocks.

Some implementations of the disclosed systems, apparatus, methods and computer-readable storage media are configured to combine feed items associated with the same database record for presentation in a feed of information. For example, when two or more feed items published to a feed are determined to have a shared attribute, such as the feed items being associated with the same record of a business organization or associated with another entity such as a user or a group of an enterprise social networking system, the associated feed items can be automatically combined. The combining of feed items is also referred to herein as “clumping”. Feed items can be “clumped” using any of various disclosed techniques to produce a representative feed item, also referred to herein as a “clump”. The clump can be displayed in a presentation of the feed, for example, in a graphical user interface (GUI) at the top of an otherwise chronological scroll of feed items. This way, a user can immediately see relevant feed information in the clump without having to scroll up-and-down through a long list of feed items to try to find feed items pertaining to a particular database record. In other words, feed items “buried” in a chronological arrangement of a feed that have some relevance to one or more attributes can be automatically identified and presented as a clump outside of the chronological sequence of items defining the feed for immediate viewing and consumption by a user.

Generally, metadata describing the clumped feed items is retrieved or generated to include in the content of the clump, and the clump is displayed separate from and in addition to the original presentations of the feed items in a feed. In some implementations, part or all of the contents of feed items are included in the clump as displayed in a feed. In some implementations, a clump is actionably linked to the feed items included therein, so a user can click on or otherwise select a displayed clump to “click through” to a presentation of all of the content of a feed item. Thus, a user can quickly access relevant feed items through the clump without having to waste time navigating through a feed arranged in chronological order. Various types of updates published as feed items can be clumped, such as posts, comments, likes, status updates, workflows, uploaded documents, shared documents, hyperlinks, task updates, notes, record updates, create events (for instance, notifying that a record has been created), meeting requests, calendar entries, lead conversions, and calls logged.

In some implementations, feed items are clumped based on a shared attribute or a combination of shared attributes as an alternative to or in addition to an association with the same business record. For instance, feed items can be clumped based on having the same or similar author, content, such as keywords, or user-assigned topics or tags. For example, two feed items could be clumped when each feed item includes content with the keyword “Acme”. Other non-limiting examples of a shared attribute of feed items serving as a basis to clump items include a reference in the items to: records having a parent-child or other hierarchical relationship in a database; records of the same type such as all accounts, opportunities, leads, cases, contacts, or contracts, etc.; a type of Customer Relationship Management (CRM) workflow such as a conversion of a lead; a document; two related documents (for instance, having the same author or pertaining to the same topic or subject matter); a type of document; a hyperlink; two related hyperlinks (for instance, hosted at the same domain); a task; a calendar entry; two related calendar entries (for instance, concerning the same subject matter); a post; a conversation thread in a feed or via email; and a status update. It should also be noted that the disclosed techniques are not limited to CRM environments and apply to any system or platform in which feed items are published and are accessible to users in one or more feeds.

In some implementations, time is a parameter in determining whether to clump feed items. That is, a determination to clump feed items can be based on gaps in time between when the feed items are published to a feed. For instance, a threshold time can be specified. If a first feed item and a second feed item are both published to a feed within the designated threshold, the first and second feed items are clumped. Those skilled in the art should appreciate that the threshold can be on the order of seconds, minutes, hours, days, months, years, etc. and can vary from implementation to implementation. The use of time thresholds can further refine the automatic selection of feed items to include in a clump. For instance, over the course of 1 month, 100 lead conversions on the same account may be published as separate feed items in a feed dedicated to that account. However, application of a time threshold of 1 week could reduce the number of lead conversions to report in the clump to a subset, such as the 10 most recent lead conversions (in the last week).

In some implementations, two or more feed items can be combined in the same clump using a shifting time window. In particular, a difference between timestamps of sequential pairs of feed items can be calculated and compared against the threshold. For example, a sales department of an organization uses an enterprise social networking system for sales personnel to interact with each other about various CRM records such as accounts, opportunities, leads, cases, contacts, contracts, etc. stored in a database. The threshold has been set at 5 minutes. Feed item 1 identifies a first conversion of a lead with an account of a customer, Acme, Inc. Feed item 1 has a timestamp of 1:12 pm on Wednesday, April 30^{th} identifying when feed item 1 was first published to a feed. Feed item 2 identifies a second lead conversion with the Acme account and has a timestamp of 1:15 pm, 3 minutes after feed item 1. Feed item 3 is a post regarding a third lead conversion with the Acme account and has a timestamp of 1:19 pm, 4 minutes after feed item 2. Feed item 4 identifies a fourth lead conversion with the Acme account and has a timestamp of 1:25 pm, 6 minutes after feed item 3. In this example, feed items 1-3 are combined in the same clump because the time difference between feed items 1 and 2 (3 minutes) and the time difference between feed items 2 and 3 (4 minutes) are both less than the 5 minute threshold. On the other hand, feed item 4 is excluded from the clump of feed items 1-3, because the time difference between feed item 4 and feed item 3 (6 minutes) is greater than the threshold. If a feed item 5 linked with the Acme account is received 2 minutes after feed item 4, a new clump would be created to include feed items 4 and 5 and possibly additional feed items linked with the Acme account and published within 5 minutes of an immediately preceding feed item.

In some other implementations, as mentioned above, two or more feed items are clumped based on whether the feed items are published within in a fixed time window. For example, using the same feed items and threshold of 5 minutes from the preceding example, the time window begins at 1:12 pm, the timestamp of feed item 1. In this alternative configuration, feed items 1 and 2 are clumped because they are less than 5 minutes apart. However, feed item 3 would be excluded from the clump of feed items 1 and 2 in this example, because feed item 3 was published 7 minutes after feed item 1. On the other hand, the timestamp of feed item 3 could define the start of another time window to determine whether any subsequent feed items would be combined into a clump with feed item 3.

Some but not all of the techniques described or referenced herein are implemented to combine feed items appearing in a social network feed. Social networking systems have become a popular way to facilitate communication among people, any of whom can be recognized as users of a social networking system. One example of a social networking system is Chatter®, provided by salesforce.com, inc. of San Francisco, Calif. salesforce.com, inc. is a provider of social networking services, CRM services and other database management services, any of which can be accessed and used in conjunction with the techniques disclosed herein in some implementations. These various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, LinkedIn®, Twitter®, Google+®, Yammer® and Jive® by way of example only.

Some social networking systems can be implemented in various settings, including organizations. For instance, a social networking system can be implemented to connect users within an enterprise such as a company or business partnership, or a group of users within such an organization. For instance, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail below.

In some social networking systems, users can access one or more social network feeds, which include information updates presented as items or entries in the feed. Such a feed item can include a single information update or a collection of individual information updates. A feed item can include various types of data including character-based data, audio data, image data and/or video data. A social network feed can be displayed in a graphical user interface (GUI) on a display device such as the display of a computing device as described below. The information updates can include various social network data from various sources and can be stored in an on-demand database service environment. In some implementations, the disclosed methods, apparatus, systems, and computer-readable storage media may be configured or designed for use in a multi-tenant database environment.

In some implementations, a social networking system may allow a user to follow data objects in the form of CRM records such as cases, accounts, or opportunities, in addition to following individual users and groups of users. The “following” of a record stored in a database, as described in greater detail below, allows a user to track the progress of that record when the user is subscribed to the record. Updates to the record, also referred to herein as changes to the record, are one type of information update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be social media messages submitted by a user or can otherwise be generated in response to user actions or in response to events. Examples of social media messages include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of a social networking system. For instance, a group of users may publish a news feed. Members of the group may view and post to this group feed in accordance with a permissions configuration for the feed and the group. Information updates in a group context can also include changes to group status information.

In some implementations, when data such as posts or comments input from one or more users are submitted to a social network feed for a particular user, group, object, or other construct within a social networking system, an email notification or other type of network communication may be transmitted to all users following the user, group, or object in addition to the inclusion of the data as a feed item in one or more feeds, such as a user's profile feed, a news feed, or a record feed. In some social networking systems, the occurrence of such a notification is limited to the first instance of a published input, which may form part of a larger conversation. For instance, a notification may be transmitted for an initial post, but not for comments on the post. In some other implementations, a separate notification is transmitted for each such information update.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. As mentioned below, the data can include social media messages created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “social network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) generally refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different types of social network feeds. A second user following a first user and a record can receive the feed items associated with the first user and the record for display in the second user's news feed, which is another type of social network feed. In some implementations, the feed items from any number of followed users and records can be combined into a single social network feed of a particular user.

As examples, a feed item can be a social media message, such as a user-generated post of text data, and a feed tracked update to a record or profile, such as a change to a field of the record. Feed tracked updates are described in greater detail below. A feed can be a combination of social media messages and feed tracked updates. Social media messages include text created by a user, and may include other data as well. Examples of social media messages include posts, user status updates, and comments. Social media messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a GUI, for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Social media messages and other types of feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and social media messages, such as posts, comments, likes, etc., can define group conversations and change over time.

An “entity feed” or “record feed” generally refers to a feed of feed items about a particular record in the database. Such feed items can include feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” generally refers to a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

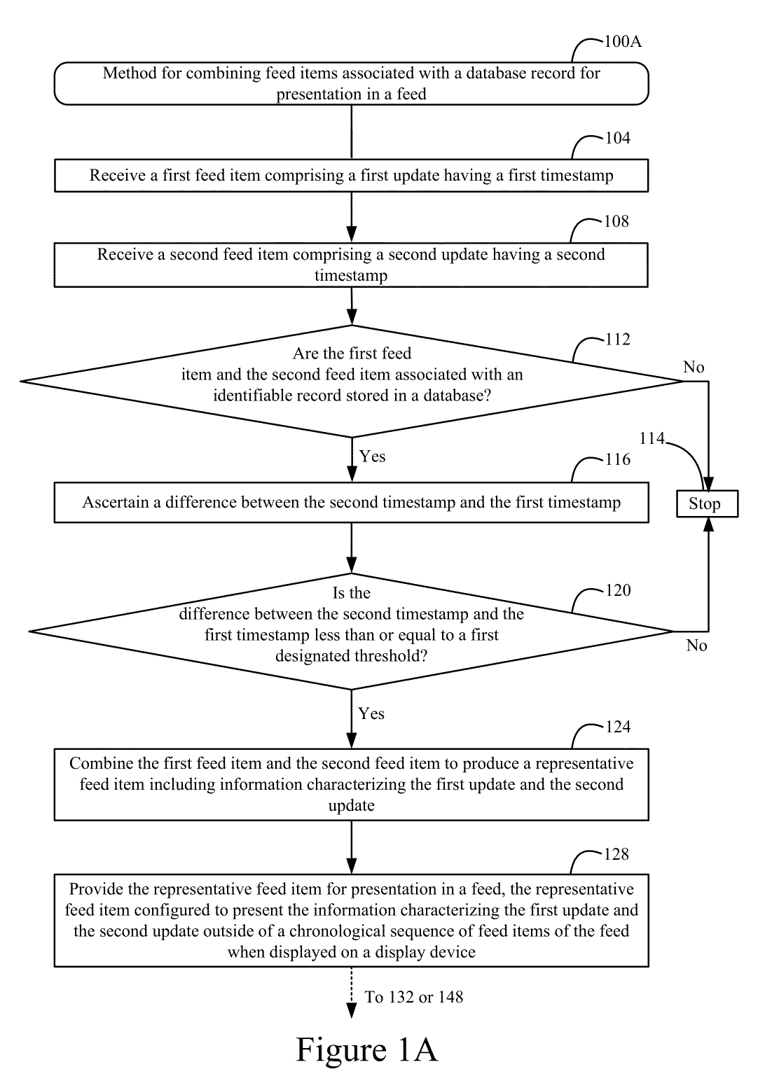

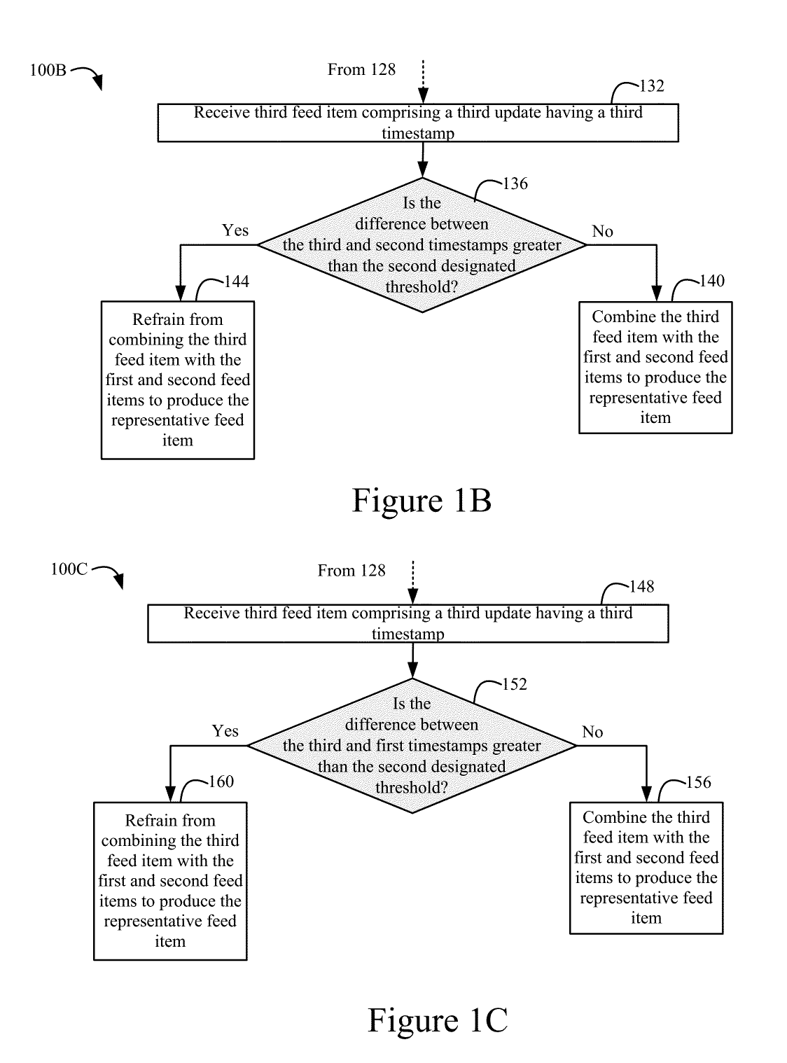

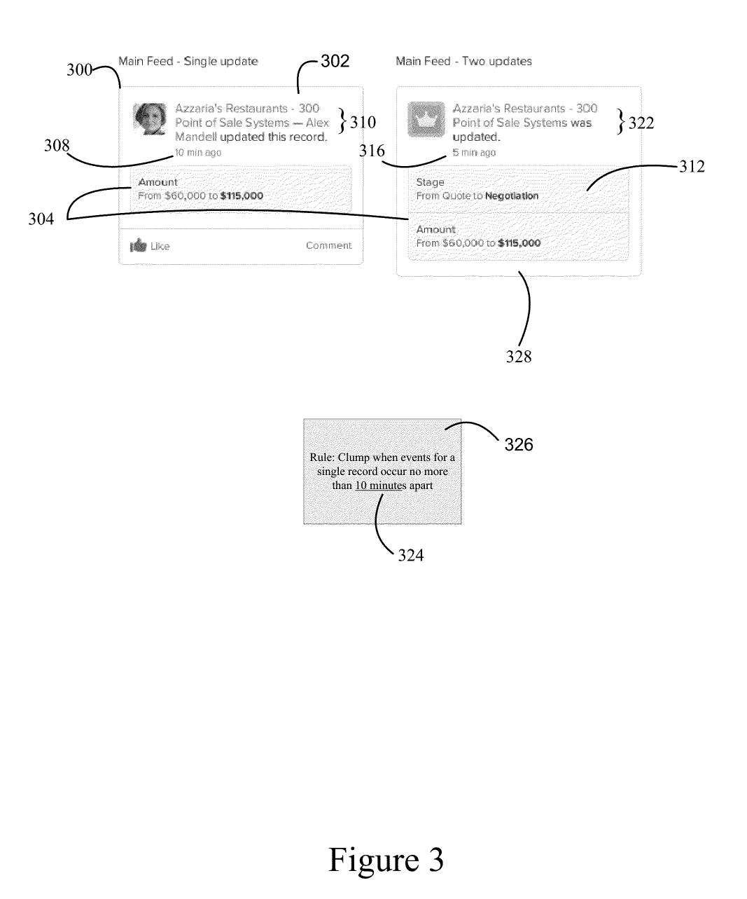

FIG. 1A shows a flowchart of an example of a computer implemented method 100A for combining feed items associated with a database record for presentation in a feed, performed in accordance with some implementations. FIG. 1A is described with reference to FIG. 3, which shows an example of a presentation of feed items in the form of a GUI as displayed on a computing device, in accordance with some implementations.

In the example of method 100A, at 104, a first feed item 300 of FIG. 3 comprising a first update 302 in the form of a record update having a first timestamp 308 of “10 minutes ago” is received at one or more servers practicing method 100A. The first update 302 includes content 304 indicating an “amount” field of a customer record named “Azzaria's Restaurants—300 Point of Sale Systems” has changed values from “$60,000 to $115,000.” The first update 302 also includes metadata 310 describing the changed in the field value, namely that a user “Alex Mandell updated this record.”

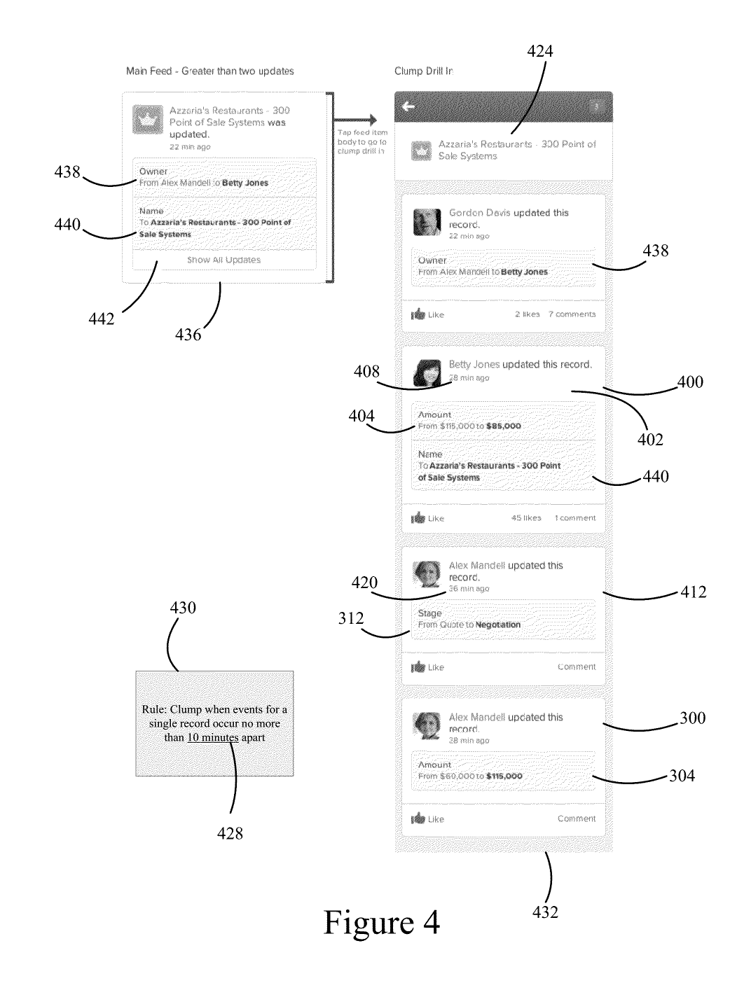

Returning to FIG. 1A, at 108, a second feed item comprising a second update 312 of FIG. 3 having a second timestamp 316 of “5 minutes ago” is received. While FIG. 3 does not show the second feed item in separate form, the second feed item is illustrated and identified by reference numeral 412 in FIG. 4 and described in greater detail below. FIG. 3 demonstrates that second update 312 is associated with the same record as first update 302, namely “Azzaria's Restaurants . . . ”, and includes content indicating the “stage” field of the record moving from “Quote to Negotiation.”

In other examples, the contents of the first and second feed items can vary greatly. Some non-limiting examples of types of content that can be reported in feed items include: social media messages (a post, a comment, a like, a status update, etc.), a workflow, an uploaded document, a shared document, a hyperlink, a task update, a note, a create event, a meeting request, a calendar entry, a lead conversion, a call logged, and a record update. It should also be noted that one or more additional feed items associated with the Azzaria's Restaurants record or another identifiable database record can be situated between the first feed item and the second feed item in a chronological sequence of feed items.

Returning to FIG. 1A, at 112, it is determined whether first feed item 300 and second feed item 412 are associated with the same record. If not, processing of method 100A terminates at 114. If so, method 100A proceeds to 116. In the example of FIG. 3, because both feed items are associated with the Azzaria's Restaurants records, method 100A proceeds to 116 at which a difference between first timestamp 308 of “10 minutes ago” and second timestamp 316 of “5 minutes ago” is ascertained to be 5 minutes. At 120, it is determined whether the difference between first timestamp 308 and second timestamp 316 of 5 minutes is less than or equal to a first designated threshold 324 of “10 minutes”, as specified by a processing rule 326 configured to be executed by a server. If the time gap between feed items is greater than the threshold, processing stops at 114 of FIG. 1A. In the example of FIG. 3, because the gap is less than 10 minutes, processing continues to 124.

At 124, first feed item 300 and second feed item 412 are combined to produce a representative feed item 328, shown in FIG. 3. The representative feed item 328 includes information characterizing first update 302 and second update 312 because content 304 of first update 302 and the content of second update 312 have been aggregated to produce representative feed item 328. Metadata 322 of representative feed item 328 has also been generated using metadata 310 of first update 302 and metadata of second update 312 to describe both updates. In the example of FIG. 3, metadata 322 informs a user viewing feed item 328 that both updates reported by feed item 328 are linked with the Azzaria's Restaurants record.

At 128 of FIG. 1A, representative feed item 328 is provided for presentation in a feed. Feed item 328 is configured to present metadata 322 characterizing first update 302 and second update 312 in any order within or outside of a chronological sequence of feed items. For instance, feed item 328 could be presented at the top of the feed as displayed on a display device or in a region adjacent to and spaced apart from a chronological scroll of feed items. The ordering of updates within feed item 328 can be by type of update, where changes in amount are listed below changes in stage as in feed item 328 as displayed in FIG. 3.

FIG. 1B shows a flowchart of an example of a computer implemented method 100B capable of being practiced in combination with method 100A for combining feed items associated with a database record for presentation in a feed, performed in accordance with some implementations. More specifically, FIG. 1B shows the handling of a third feed item after processing the first and second feed items as shown in FIG. 1A. FIG. 1B is described with reference to FIG. 4, which shows another example of a presentation of feed items in the form of a GUI as displayed on a computing device, in accordance with some implementations.

In FIG. 1B, at 132, a third feed item 400 of FIG. 4 comprising a third update 402 in the form of a record update having a third timestamp 408 of “28 minutes ago” is received. The third update 402 includes content 404 indicating a change to the “Amount” field of the Azzaria's Restaurants record from $115,000 to $85,000. The second feed item 412 described above comprises second update 312 also described above. At the time of the presentation of FIG. 4, 36 minutes have elapsed since the original publication of feed item 412, and thus the second timestamp has been updated to “36 minutes ago” as indicated by reference numeral 420.

A difference between third timestamp 408 of third feed item 400 and second timestamp 420 of second feed item 412 is determined to be 8 minutes. At 136 of FIG. 1B, it is determined whether this difference of 8 minutes is greater than a second designated threshold 428 of 10 minutes, as indicated by a second processing rule 430 shown in FIG. 4. Because the difference is less than or equal to the second threshold, the third feed item is combined with the first and second feed items to produce an updated representative feed item having a collapsed state 436 of FIG. 4, at 140 in FIG. 1B. In the example of FIG. 4, collapsed state 436 of the representative feed item is a collapsed presentation of feed items 300, 400 and 412 and other feed items pertaining to the Azzaria's Restaurants record. The collapsed state 436 displays two most recent updates 438 and 440, while feed items 300, 400 and 412 have been collapsed into a “Show All Updates” button 442. Partial or full presentations of the contents of feed items 300, 400 and 412 can be presented in an uncollapsed state 432 of the representative feed item when a user taps or other selects Show All Updates button 442.

In some implementations, the feed items displayed in uncollapsed state 432 or collapsed state 436 of the representative feed item include links to the same feed items as displayed in one or more chronological feeds, such as the Azzaria's Restaurants feed or the viewing user's news feed. For instance, when only partial views of the contents of feed items in uncollapsed state 432 are shown, it may be desirable to tap on a feed item of interest to view a full presentation of the feed item's content.

Returning to FIG. 1B, at 136, in situations other than the example of FIG. 4, the difference between the third and the second timestamps may be greater than the second designated threshold. If this is the case, the response at 144 is to refrain from combining the third feed item 400 with the first and second feed items 300 and 412 to produce a representative feed item.

In some implementations of FIG. 1B, such as the particular scenario of FIG. 4, the first and second thresholds can have the same value. In some other implementations, the first and second thresholds can have different values. For example, when the first and second thresholds have different values, the second threshold can serve as a maximum time beyond which no combining of feed items occurs. For instance, the first designated threshold could be 10 minutes, as described above, and the second designated threshold could be 24 hours. If a first feed item is published at time t=0 and a third feed item is published 25 hours later, the third feed item would not be combined to produce a representative feed item because, at 136, the time difference would exceed the second designated threshold.

In some other implementations, feed items are combined to form a representative feed item based at least in part on whether the feed items are received within a fixed time window. For example, in the case of first, second and third feed items published in sequence in association with the same database record, the timestamp of the third feed item in the sequence is compared with the timestamp of the first feed item rather than the timestamp of the second feed item or any feed items following the first feed item. Such implementations are addressed in FIG. 1C, which shows a flowchart of an example of a computer implemented method 100C capable of being practiced in combination with method 100A for combining feed items associated with a database record for presentation in a feed.

In FIG. 1C, at 148, third feed item 400 shown in FIG. 4 is received, where first and second feed items 300 and 412 have been processed as described above with reference to FIG. 1A. Unlike FIG. 1B, a difference is ascertained between the third timestamp of feed item 400, 28 minutes ago, and the first timestamp, 38 minutes ago as shown in FIG. 4. At 152, the difference between the first and third timestamps, 10 minutes in this example, is compared with a second designated threshold. At 152, if the difference is less than or equal to the second designated threshold, at 156, third feed item 400 is combined with first and second feed items 300 and 412 to produce a representative feed item, states of which are shown in FIG. 4 as described above. In instances where the difference between the first and third timestamps is greater than the second designated threshold, at 160, a server implementing part or all of the processing of FIG. 1C refrains from combining the third feed item with the first and second feed items in a representative feed item.

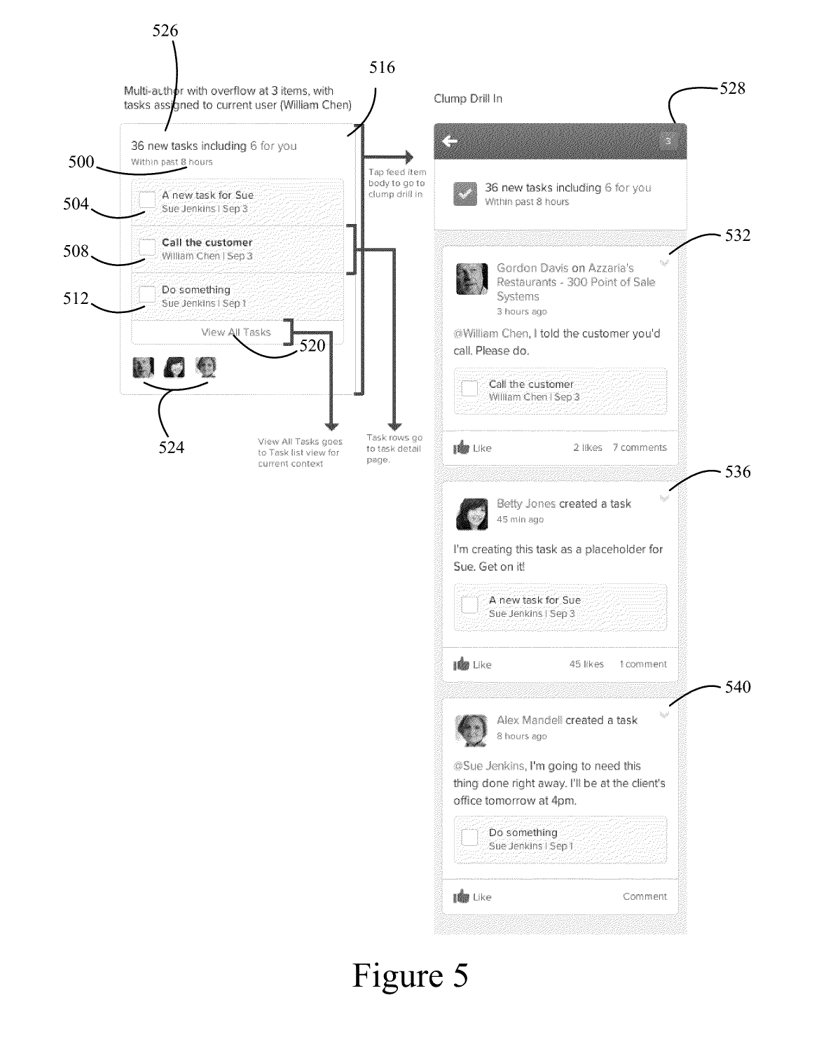

Another example of a fixed window approach is combining feed items with content relating to tasks assigned in the same day, that is, where the time threshold is specified as 24 hours. In the case of FIG. 5, as alternative to a 24-hour period, the time threshold is set at 8 hours. In FIG. 5, a first feed item 504, a second feed item 508, and a third feed item 512 each report a respective task create event, that is, an update identifying a new task which has been created, where the associated tasks are assigned to members of the same workgroup. The feed items 504, 508 and 512 are all received within an 8 hour period as indicated by reference numeral 500, so they are combined into a representative feed item 516. A “View All Tasks” button 520 allows the viewing user to click through to a full list of the tasks in representative feed item 516.

In some implementations, a representative feed item might contain information summarizing feed items combined in the representative feed item. For instance, included in representative feed item 516 are pictures 524. Each picture 524 is associated with a user who has created one or more tasks identified in representative feed item 516 or to whom one or more tasks have been assigned. Additionally, a heading 526 has been generated to include metadata indicating that representative feed item 516 contains information relating to “36 new tasks including 6 for you,” referring to the user viewing the presentation of FIG. 5.

FIG. 5 also illustrates a “clump drill in” selection. If a user taps representative feed item 516, the user can view clump drill in 528. The clump drill in 528 contains more details of each feed item 504, 508 and 512 presented in the representative feed item 516. For instance, detailed feed item 532, corresponds to second feed item 508, contains details not included in second feed item 508, such as a timestamp, an identification of the task creator, a reference to a database record, and a social media message accompanying the task. In detailed feed item 532, Gordon Davis, creator of the task associated with second feed item 508, explains to William Chen in a post that Gordon “told the customer” that William Chen would call. Along the same lines, detailed feed items 536 and 540 are associated with first feed item 504 and third feed item 512 respectively. Like detailed feed item 532, detailed feed items 536 and 540 contain further information about their associated tasks from each task creator to each person to whom a task is assigned.

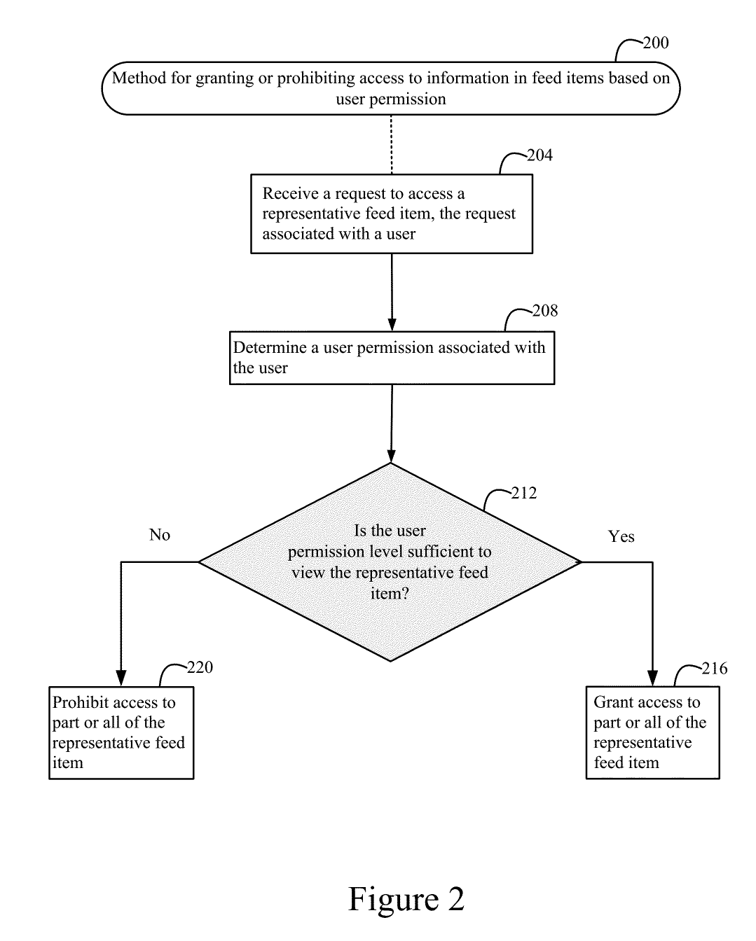

FIG. 2 shows a flowchart of an example of a computer implemented method 200 for granting or prohibiting access to information in feed items based on a user permission, performed in accordance with some implementations. FIG. 2 can be performed in combination with or apart from the examples of FIGS. 1A, 1B, and 1C. In this particular example, assume that representative feed item 328 of FIG. 3 has been generated as described above with reference to FIG. 1A. At 204 of FIG. 2, a request to access representative feed item 328 or any feed items clumped in representative feed item 328 is received from a user, for instance, when the user taps or clicks on feed item 328. At 208, a user permission associated with the requesting user is determined. For example, the user's profile or a security database showing access rights and restrictions for users of a social networking system can be checked to determine the user's clearance. At 212, it is determined whether the user permission establishes that the user has clearance to view the requested feed item. If the user has clearance, at 216, access to part or all of the requested feed item is granted. Otherwise, at 212, when the user permission is insufficient, access to part or all of the representative feed item is prohibited at 220.

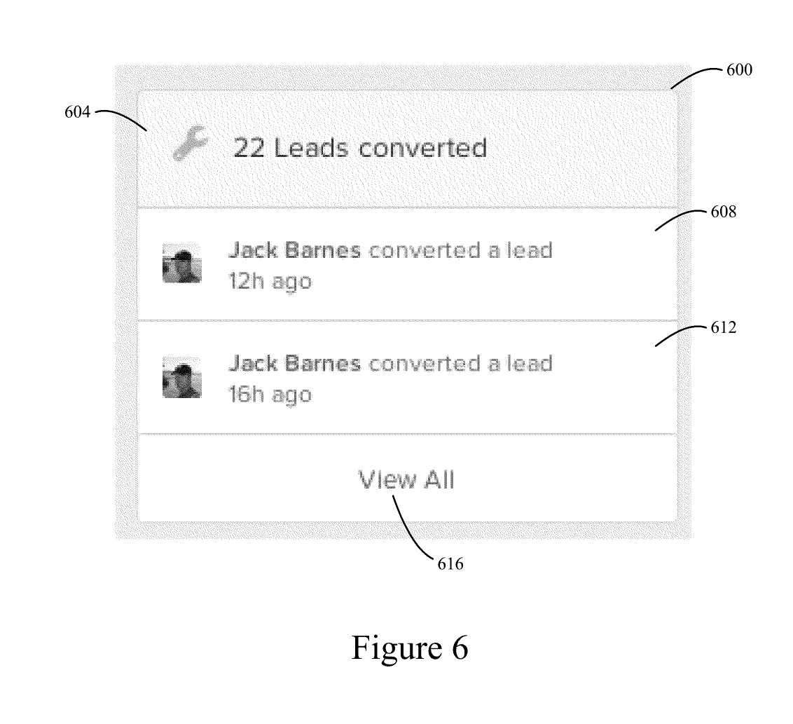

FIG. 6 illustrates another example of a presentation of feed items in the form of a GUI as displayed on a computing device, in accordance with some implementations. More specifically, FIG. 6 shows a representative feed item 600, containing information about lead conversions associated with an account. A heading 604 of representative feed item 600 includes metadata identifying 22 leads which have been converted on the same account. A user can see the two most recent lead conversions on the account in a first update 608 and a second update 612. In order to see the remaining lead conversions in the clump, a user can click a “View All” button 616.

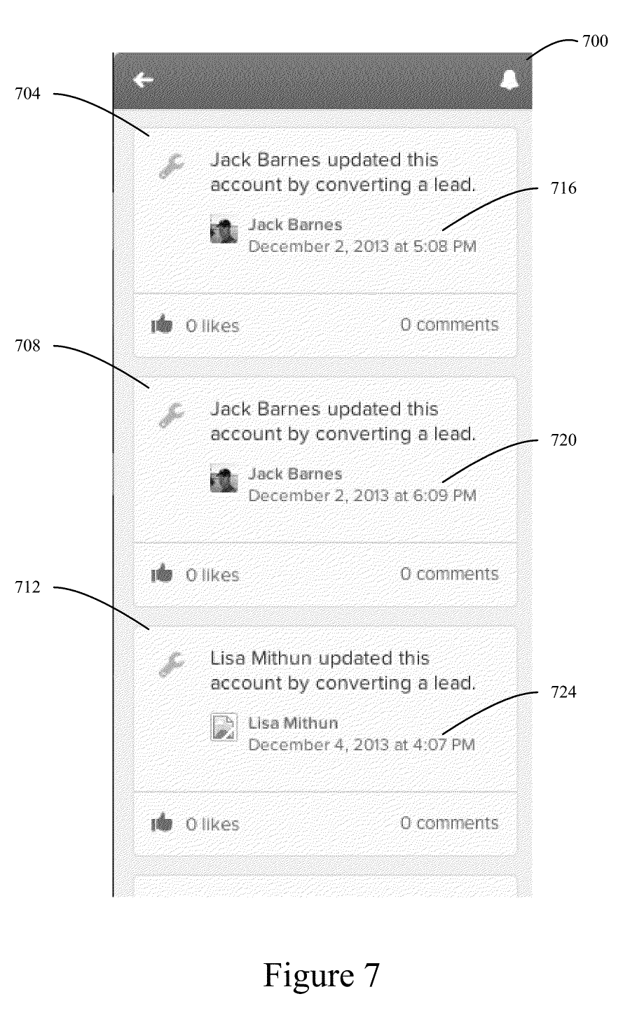

In some implementations, after clicking “View All” button 616, a longer and more detailed presentation of representative feed item 600 is generated for display. An example of such a detailed representative feed item 700 is shown in FIG. 7. Representative feed item 700 includes a first update 704, a second update 708, and a third update 712 all containing information about three recent lead conversions associated with an account. Notably, timestamps 716, 720, and 724 demonstrate that the three updates 704, 708, and 712 are not displayed in chronological order. Rather, the updates 704, 708, and 712 are ordered based on the user associated with each update. For example, first update 704, having timestamp 716 of Dec. 2, 2013 at 5:08 P.M., and second update 708, having timestamp 720 of Dec. 2, 2013 at 6:09 P.M., are both associated with user “Jack Barnes,” and are, therefore, displayed at the top of representative feed item 700. On the other hand, third update 712, having the most recent timestamp of Dec. 4, 2013, is associated with user Lisa Mithun. Third update 712 is displayed below first update 704 and second update 708 because third update 712 is associated with a different user.

Systems, apparatus, and methods are described below for implementing database systems and enterprise level social and business information networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

By way of example, a user can update a record in the form of a CRM object, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed to the manager's feed page or other page.

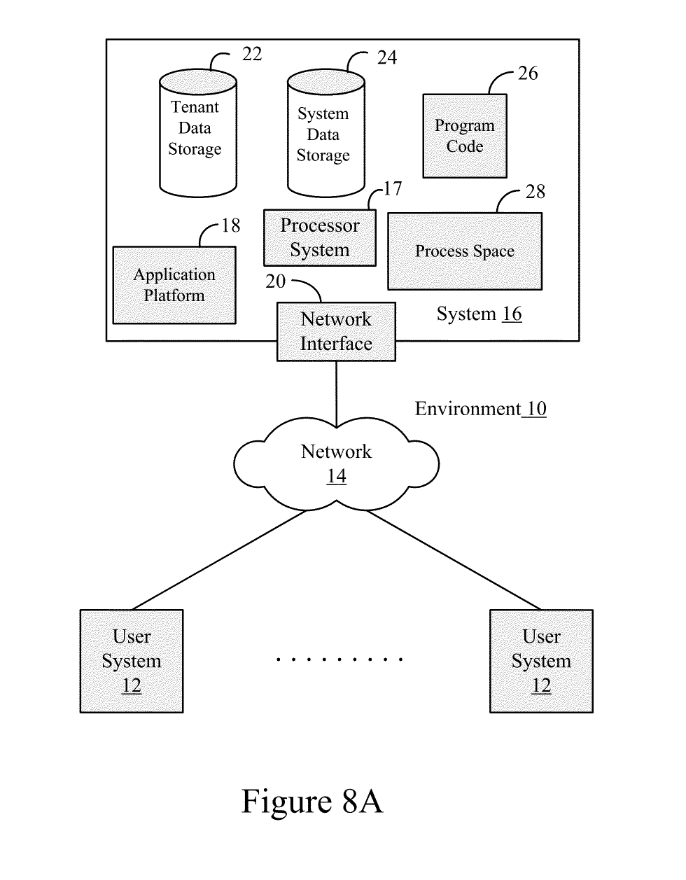

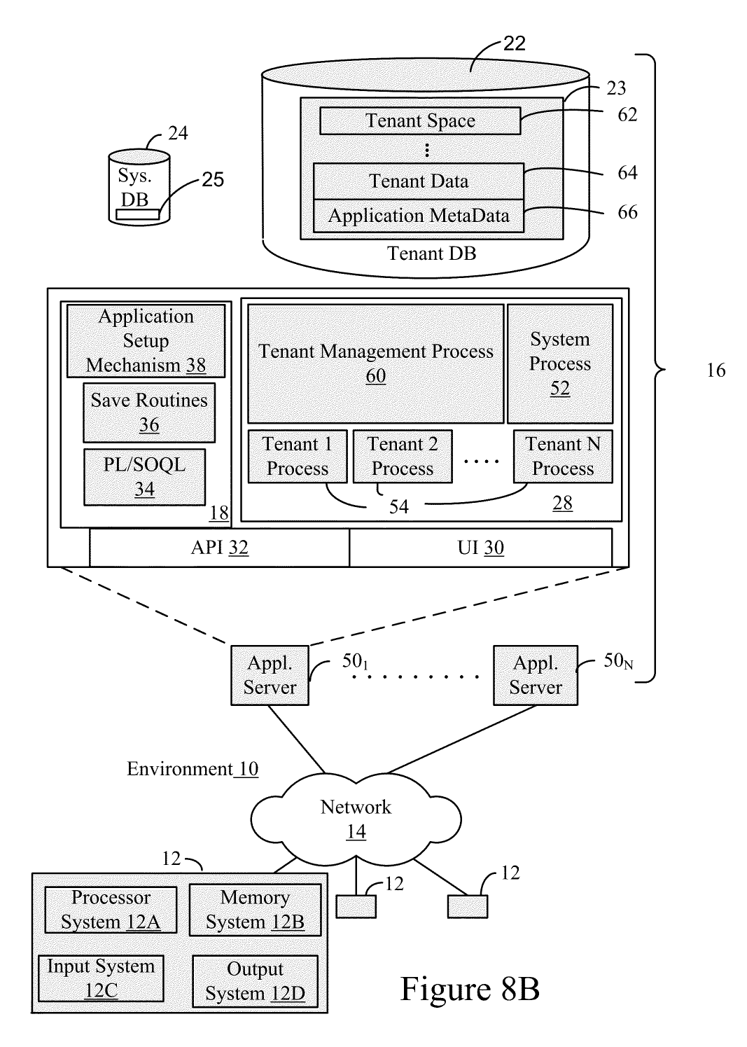

FIG. 8A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 8A (and in more detail in FIG. 8B) user systems 12 might interact via a network 14 with an on-demand database service, which is implemented in the example of FIG. 8A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 8A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 8A and 8B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 8A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 8B shows a block diagram of an example of some implementations of elements of FIG. 8A and various possible interconnections between these elements. That is, FIG. 8B also illustrates environment 10. However, in FIG. 8B elements of system 16 and various interconnections in some implementations are further illustrated. FIG. 8B shows that user system 12 may include processor system 12A, memory system 12B, input system 12C, and output system 12D. FIG. 8B shows network 14 and system 16. FIG. 8B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 8A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 8B, system 16 may include a network interface 20 (of FIG. 8A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

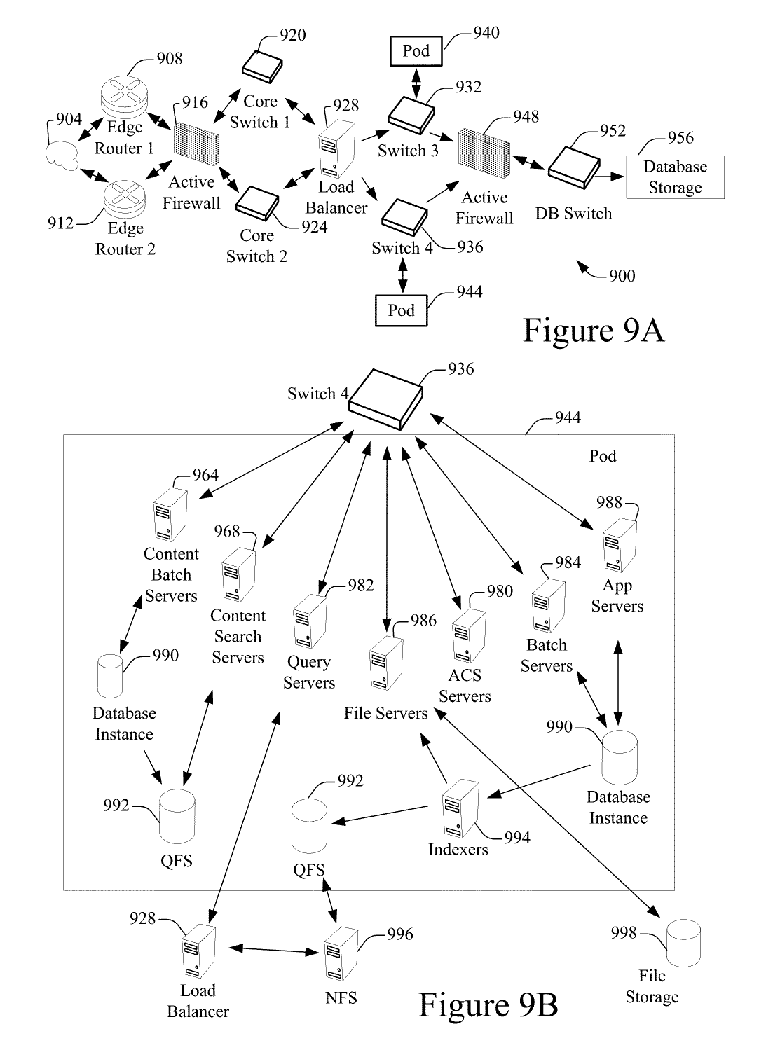

FIG. 9A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 9A and 9B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 9A and 9B, some implementations of an on-demand database service environment may include anywhere from one to many devices of each type. Also, the on-demand database service environment need not include each device shown in FIGS. 9A and 9B, or may include additional devices not shown in FIGS. 9A and 9B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 9B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 8A and 8B.

FIG. 9B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

In some implementations, the app servers 988 may include a hardware and/or software framework dedicated to the execution of procedures (e.g., programs, routines, scripts) for supporting the construction of applications provided by the on-demand database service environment 900 via the pod 944. In some implementations, the hardware and/or software framework of an app server 988 is configured to execute operations of the services described herein, including performance of one or more of the blocks of methods described herein with reference to FIGS. 1-7 In alternative implementations, two or more app servers 988 may be included to perform such methods, or one or more other servers described herein can be configured to perform part or all of the disclosed methods.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (“ROM”) devices and random access memory (“RAM”) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. One or more computing devices for combining feed items associated with a database record for presentation in a feed, the one or more computing devices comprising:
one or more processors operable to cause a computing device to:
receive a first feed item comprising a first update having a first timestamp;
receive a second feed item comprising a second update having a second timestamp;
determine that the first feed item and the second feed item are associated with an identifiable one of a plurality of records stored in a database, the records storing business information of a business organization;
ascertain a difference between the second timestamp and the first timestamp;
determine that the difference between the second timestamp and the first timestamp is less than or equal to a first designated threshold;
combine, responsive to both the first feed item and the second feed item being associated with the identifiable database record and the difference between the second timestamp and the first timestamp being less than or equal to the first designated threshold, the first feed item and the second feed item to produce a representative feed item including information characterizing the first update and the second update; and
provide the representative feed item for presentation in a feed, the representative feed item configured to present the information characterizing the first update and the second update outside of a chronological sequence of feed items of the feed when displayed on a display device.

2. The one or more computing devices of claim 1, wherein the second feed item follows the first feed item in the chronological sequence of feed items.

3. The one or more computing devices of claim 1, wherein a third feed item associated with the identifiable database record is situated between the first feed item and the second feed item in the chronological sequence of feed items.

4. The one or more computing devices of claim 1, the one or more processors further operable to cause a computing device to:
receive a third feed item comprising a third update having a third timestamp;
determine that the third feed item is associated with the identifiable record;
ascertain a difference between the third timestamp and the second timestamp;
determine that the difference between the third timestamp and the second timestamp is greater than a second designated threshold; and
refrain, responsive to the difference between the third timestamp and the second timestamp being greater than the second designated threshold, from combining the third feed item with the first and second feed items to produce the representative feed item.

5. The one or more computing devices of claim 4, wherein the second designated threshold and the first designated threshold have the same value.

6. The one or more computing devices of claim 4, wherein the second designated threshold and the first designated threshold have different values.

7. The one or more computing devices of claim 1, the one or more processors further operable to cause a computing device to:
receive a third feed item comprising a third update having a third timestamp;
determine that the third feed item is associated with the identifiable record;
ascertain a difference between the third timestamp and the first timestamp;
determine that the difference between the third timestamp and the first timestamp is greater than the first designated threshold; and
refrain, responsive to the difference between the third timestamp and the second timestamp being greater than the first designated threshold, from combining the third feed item with the first and second feed items to produce the representative feed item.

8. The one or more computing devices of claim 1, wherein combining the first feed item and the second feed item to produce the representative feed item comprises:
generating first metadata characterizing the first feed item,
generating second metadata characterizing the second feed item, and
providing the first metadata and the second metadata as content of the representative feed item.

9. The one or more computing devices of claim 1, wherein combining the first feed item and the second feed item to produce the representative feed item comprises one or more of: aggregating content of the first feed item with content of the second feed item, collapsing a presentation of the first feed item and a presentation of the second feed item into a presentation of the representative feed item, and linking the representative feed item with the first and second feed items.

10. The one or more computing devices of claim 1, the one or more processors further operable to cause a computing device to:
determine that the first feed item and the second feed item have one or more shared attributes, the instruction to combine the first feed item and the second feed item to produce the representative feed item being performed further responsive to both the first feed item and the second feed item having the one or more shared attributes.

11. The one or more computing devices of claim 10, wherein the shared attributes comprise the first feed item and the second feed item both containing information related to one or more of: a single or related documents, a single or related hyperlinks, a single or related opportunities, a single or related accounts, a single or related tasks, a single or related calendar entries, a single social media message or related social media messages, a single or related status updates, a single or related records, and a single or related lead conversions.

12. The one or more computing devices of claim 1, wherein the database records are customer relationship management (CRM) records comprising one or more of: an account, a task, a lead, a contact, a contract and an opportunity.

13. The one or more computing devices of claim 1, wherein each of the first and second feed items includes one or more of: a post, a comment, a like, a status update, a workflow, an uploaded document, a shared document, a hyperlink, a task update, a note, a create event, a meeting request, a calendar entry, a lead conversion, a call logged, and a record update.

14. The one or more computing devices of claim 1, the one or more processors further operable to cause a computing device to:
receive a request to access the feed, the request associated with a user;
determine a user permission associated with the user;
grant or prohibit access to part or all of the representative feed item based at least in part on the user permission.

15. The one or more computing devices of claim 1, wherein the display device is one of: a desktop computer, a laptop computer, a tablet, a smartphone, and a wearable device.

16. A method for combining feed items associated with a database record for presentation in a feed, the method comprising:
receiving a first feed item comprising a first update having a first timestamp;
receiving a second feed item comprising a second update having a second timestamp;
determining, by a computing device, that the first feed item and the second feed item are associated with an identifiable one of a plurality of records stored in a database, the records storing business information of a business organization;
ascertaining a difference between the second timestamp and the first timestamp;
determining that the difference between the second timestamp and the first timestamp is less than or equal to a first designated threshold;
combining, responsive to both the first feed item and the second feed item being associated with the identifiable database record and the difference between the second timestamp and the first timestamp being less than or equal to the first designated threshold, the first feed item and the second feed item to produce a representative feed item including information characterizing the first update and the second update; and
providing the representative feed item for presentation in a feed, the representative feed item configured to present the information characterizing the first update and the second update outside of a chronological sequence of feed items of the feed when displayed on a display device.

17. The method of claim 16, further comprising:
receiving a third feed item comprising a third update having a third timestamp;
determining that the third feed item is associated with the identifiable record;
ascertaining a difference between the third timestamp and the second timestamp;
determining that the difference between the third timestamp and the second timestamp is greater than a second designated threshold; and
refraining, responsive to the difference between the third timestamp and the second timestamp being greater than the second designated threshold, from combining the third feed item with the first and second feed items to produce the representative feed item.

18. The method of claim 16, wherein combining the first feed item and the second feed item to produce the representative feed item comprises:
generating first metadata characterizing the first feed item;
generating second metadata characterizing the second feed item; and
providing the first metadata and the second metadata as content of the representative feed item.

19. The method of claim 16, wherein combining the first and second feed items to produce the representative feed item comprises one or more of: aggregating content of the first feed item with content of the second feed item, collapsing a presentation of the first feed item and a presentation of the second feed item into a presentation of the representative feed item, and linking the representative feed item with the first and second feed items.

20. The method of claim 16, further comprising:
receiving a request to access the feed, the request associated with a user;
determining a user permission associated with the user; and
granting or prohibiting access to part or all of the representative feed item based at least in part on the user permission.

21. A non-transitory computer-readable storage medium storing instructions executable by a processor to cause a method to be performed for combining feed items associated with a database record for presentation in a feed, the method comprising:
receiving a first feed item comprising a first update having a first timestamp;
receiving a second feed item comprising a second update having a second timestamp;
determining, by a computing device, that the first feed item and the second feed item are associated with an identifiable one of a plurality of records stored in a database, the records storing business information of a business organization;
ascertaining a difference between the second timestamp and the first timestamp;
determining that the difference between the second timestamp and the first timestamp is less than or equal to a first designated threshold;
combining, responsive to both the first feed item and the second feed item being associated with the identifiable database record and the difference between the second timestamp and the first timestamp being less than or equal to the first designated threshold, the first feed item and the second feed item to produce a representative feed item including information characterizing the first update and the second update; and
providing the representative feed item for presentation in a feed, the representative feed item configured to present the information characterizing the first update and the second update outside of a chronological sequence of feed items of the feed when displayed on a display device.

22. The non-transitory computer-readable storage medium of claim 21, the method further comprising:
receiving a third feed item comprising a third update having a third timestamp;
determining that the third feed item is associated with the identifiable record;
ascertaining a difference between the third timestamp and the second timestamp;
determining that the difference between the third timestamp and the second timestamp is greater than a second designated threshold; and
refraining, responsive to the difference between the third timestamp and the second timestamp being greater than the second designated threshold, from combining the third feed item with the first and second feed items to produce the representative feed item.

23. The non-transitory computer-readable storage medium of claim 21, the method further comprising:
generating first metadata characterizing the first feed item;
generating second metadata characterizing the second feed item; and
providing the first metadata and the second metadata as content of the representative feed item.

24. The non-transitory computer-readable storage medium of claim 21, wherein combining the first and second feed items to produce the representative feed item comprises one or more of: aggregating content of the first feed item with content of the second feed item, collapsing a presentation of the first feed item and a presentation of the second feed item into a presentation of the representative feed item, and linking the representative feed item with the first and second feed items.

25. The non-transitory computer-readable storage medium of claim 21, the method further comprising:
receiving a request to access the feed, the request associated with a user;
determining a user permission associated with the user; and
granting or prohibiting access to part or all of the representative feed item based at least in part on the user permission.
